(19) United States
(12) Patent Application Publication
(10) Pub. No.: US 2025/0332497 A1
(43) Pub. Date: Oct. 30, 2025

(54) CHIP STRAP

(71) Applicant: BELOWIPP, LLC, Bismarck, ND (US)

(72) Inventors: Kenneth BELOHLAVEK, Bismarck, ND (US); Travis WIPPERLING, Bismarck, ND (US)

(73) Assignee: BELOWIPP, LLC, Bismarck, ND (US)

(21) Appl. No.: 19/190,084

(22) Filed: Apr. 25, 2025

Related U.S. Application Data
(60) Provisional application No. 63/639,582, filed on Apr. 26, 2024.

(51) Int. Cl. A63B 69/36; A63B 71/02; G01B 3/1056

(52) U.S. Cl. CPC A63B 69/3658; A63B 71/023; G01B 3/1056; A63B 2071/024; A63B 2214/00; A63B 2220/20

(57) ABSTRACT

An apparatus implements a chip strap. The apparatus includes a strap. The apparatus further includes a set of target markings on the strap corresponding to a set of distances. The apparatus further includes a set of grommets inserted into the strap.

### CROSS REFERENCE TO RELATED APPLICATIONS

This application claims the benefit of U.S. Provisional Application 63/639,582, filed Apr. 26, 2024, which is incorporated by reference herein.

### BACKGROUND

Golfers may struggle with the short game, the series of shots played on and around the green, including chipping, pitching, and putting, which utilize precision and control to successfully complete a hole. Training aids that may be used for the short game may be cumbersome, difficult to store, or ineffective in providing accurate distance feedback. Some training aids, such as ropes or nylon webbing, may be heavy, fade in the sun, or damage the grass. Additionally, training aids may not provide clear distance markings or be easy to store and transport.

### SUMMARY

In general, in one or more aspects, the disclosure relates to an apparatus implementing a chip strap. The apparatus includes a strap. The apparatus further includes a set of target markings on the strap corresponding to a set of distances. The apparatus further includes a set of grommets inserted into the strap.

In general, in one or more aspects, the disclosure relates to a method that manufactures a chip strap. The method involves extending a strap. The method further involves applying a set of target markings to the strap. The method further involves inserting a set of grommets into the strap.

In general, in one or more aspects, the disclosure relates to a method using a chip strap. The method involves securing a strap to a ground. The method further involves positioning a ball at a first end of the strap. The method further involves hitting the ball towards a target marking on the strap.

Other aspects of one or more embodiments may be apparent from the following description and the appended claims.

### BRIEF DESCRIPTION OF DRAWINGS

FIG. 1 shows a diagram in accordance with the disclosure.

FIG. 2A and FIG. 2B show methods in accordance with the disclosure.

FIG. 3 shows an example in accordance with the disclosure.

Similar elements in the various figures may be denoted by similar names and reference numerals. The details of features and elements described in one figure may extend to similarly named features and elements in different figures.

### DETAILED DESCRIPTION

The present disclosure provides a lightweight, durable, and easy-to-store training aid for practicing chip shots to improve the short game. Embodiments of the disclosure use polypropylene webbing with clearly observable distance markings and grommets for secure placement. The polypropylene webbing is weather-resistant, does not kill grass, and may be easily rolled up for storage in a golf bag. The chip strap may be a yellow color for high visibility with black painted numbers for high contrast. The chip strap may include grommets for secure placement and easy identification of distances.

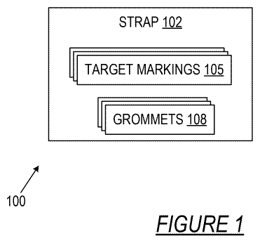

Turning to FIG. 1, the chip strap (100) may be used to practice chipping for golf. The chip strap (100) includes the strap (102). The strap (102) may be polypropylene webbing of any length, width, and thickness. The strap (102) may also be made of various other materials, such as rope, nylon webbing, polyester, and foldable tent-type poles.

The strap (102) as shown in FIG. 1 includes the target markings (105) and the grommets (108). The target markings (105) may be in the form of numbers that identify distances from one end of the strap (102) to another end of the strap (102). The grommets (108) may be placed within the strap (102) at useful or necessary intervals and used in conjunction with a set of golf tees to secure the strap (102) to a ground. The grommets (108) may also be used to keep the strap in a straight line and keep the strap from twisting, folding, or buckling.

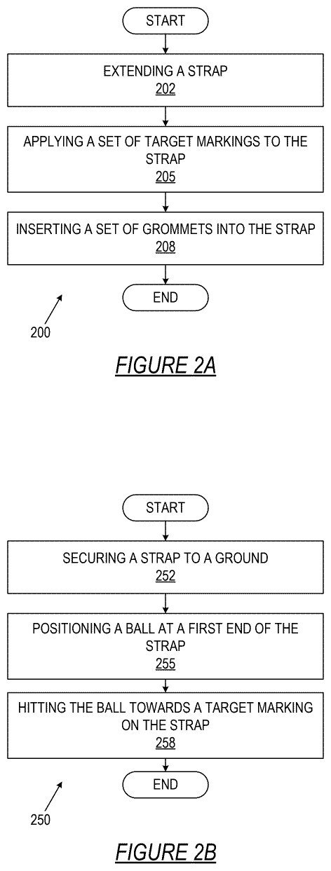

Turning to FIG. 2A, the process (200) may be used to manufacture a chip strap such as, the chip strap (100) of FIG. 1. The process (200) may include several steps.

Step 202 involves extending a strap during manufacturing. A length of polypropylene webbing (or similar) is measured and cut to the desired length for the chip strap. The webbing may be selected for durability, weather resistance, and lightweight properties. While manufacturing, the strap itself is laid out flat on a clean, smooth surface free from twists and folds, which could affect the accuracy of the target markings and the placement of grommets.

Step 205 involves applying a set of target markings to the strap. The set of target markings are applied to the strap by painting (or similar techniques) once the strap is extended. The markings may be numbers (or other indicators) that indicate distances in yards from one end of the strap to the other. The target markings may be consecutively numbers or may skip certain numbers depending on the application or spacing needs. For example, only the odd or even target markings may be placed on the strap.

The numbers may be painted using high-contrast fabric paint, which adheres well to polypropylene and resists fading in sunlight. The fabric paint may also be reflective or have other characteristics to make the target markings visible to the golfer and other participants or students. Each number may be measured and positioned for accuracy, with the center of each number marking the actual yardage. The height, width, spacing, and placement of the numbers may be proportionate to the width of the strap, enhancing visibility.

Step 208 involves inserting a set of grommets into the strap. The set of grommets may be inserted into the strap at specified intervals after the target markings are applied. To insert a grommet, a hole is first punched into the webbing at the designated location using a grommet punch tool. The hole size matches the inside diameter of the grommet, ensuring a snug fit. The grommet hole is sized to accommodate the use of a golf tee (or similar) to secure the strap to the surface.

A grommet is placed through the hole from one side of the strap, and a washer is positioned on the opposite side. The grommet and washer are then aligned and pressed together using a grommet setting tool, which crimps the grommet securely in place. The process is repeated for each grommet, e.g., at the proximal end, at regular intervals (e.g., 5 yards), and at the distal end (e.g., yard 15 or 20).

Turning to FIG. 2B, the process (250) may use a chip strap. The process (250) may include several steps.

Step 252 includes securing a strap to the ground. The chip strap is unrolled and laid flat on the ground in the desired practice area, such as a yard, park, or golf course. The strap is positioned so that the target markings are clearly visible. To secure the strap, golf tees are inserted through the grommets at regular intervals. The golf tees are pushed firmly into the ground, ensuring the strap remains taut and stable, even in rolling terrain or windy conditions.

Step 255 includes positioning a ball at a first end of the strap. Once the strap is secured, a golf ball is placed at the proximal end of the strap, which may be marked as yard 0. The golfer positions to take a shot with a clear view of the target markings along the length of the strap. The positioning establishes the starting point for measuring the accuracy and distance of each chip shot.

Step 258 includes hitting the ball towards a target marking on the strap. The golfer takes aim at one of the target markings on the strap and executes a chip shot. The goal is to land the ball as close to the desired target marking as possible. The practice develops precision and control in the short game. After each shot, the distance and accuracy are assessed, making adjustments to technique. Hitting the ball may be repeated for various target markings to practice different distances and improve chipping skills and muscle memory.

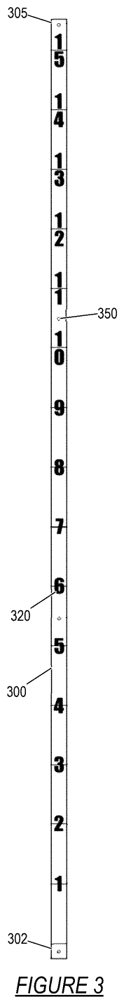

Turning to FIG. 3, the chip strap (300) may be an embodiment of the chip strap (100) of FIG. 1. In this example, the chip strap (300) may be constructed using polypropylene webbing, for weather resistance, durability, and lightweight properties. The chip strap (300) does not kill grass if left after use and may be easily rolled up for storage in a golf bag. The fabric paint used for the numbers (320) on the chip strap (300) adhere to the chip strap (300) and does not easily fade in the sun. Nevertheless, rolling up the chip strap for storage after each use is advisable. The chip strap (300) may be a specific width (e.g., 2 inches wide, 3 inches wide, 4 inches wide, etc.), to be small enough to handle and large enough to see. In one embodiment, the yellow color of the chip strap (300) provides high contrast for the black painted numbers, enhancing visibility against the grass.

Additional materials that could be used for the chip strap include rope, nylon webbing, polyester, and foldable tent-type poles. The rope may use 0.5 inch diameter with tape or knots to mark distances. Nylon webbing may be used but may be heavier than polypropylene, may fade in the sun, and may kill grass if left out. Polyester may be used and may be stronger than polypropylene for the chip strap (300). Foldable tent-type poles may be used but may be heavier and may be difficult to store in a golf bag as compared to polypropylene.

In one embodiment, the chip strap (300) measures distances in yards, with each number (320) being a specific height and width (e.g., 3 inches tall and 1.75 inches wide). In one embodiment, the height and width of the numbers may be proportionate to the width of the strap to increase visibility. In one embodiment, the center of each number may mark the actual yardage. Certain embodiments may include a line to mark the distance or have the mark for distance above, below, or in the middle of each number. For two digit numbers, the line may be between the two digits.

The chip strap (300) may include the grommets (350) (e.g., five grommets), one at the proximal end (302) of the chip strap (300), one each 5 yards, and at the distal end (305) (e.g., at yard 15 of the chip strap (300)). In one embodiment, the grommets (350) secure the strap in the wind and provide quick identification of distances. In one embodiment, the grommets (350) may be black self-piercing grommets with neck washers for added support. In one embodiment, spur grommets may also be used. In one embodiment, a size 0 grommet may be used with an inside diameter of 0.25 inch, allowing golf tees to secure the chip strap (300).

In one embodiment, the chip strap (300) is 15 yards in length. Other lengths may be used. For example, a 20 yard length may be suitable for backyard practice. When rolled up, the 20 yard strap may be 8 inches in diameter to fit within a golf bag. Custom sizes, such as 25 or 30 yards, may also be used.

In one embodiment, the chip strap (300) may be used in multiple methods. A first method involves unrolling the strap in a yard, park, or golf course, starting from the beginning and working distances out. A second method involves rolling out the strap from the edge of the green at a golf course. In particular, with the second method, the strap is placed on the green and the player works back from the green.

Further, in one embodiment, the strap may be extended in distance by using multiple chip straps and securing the distal end (305), the rest of the chip strap (300) around the distal end, to secure the proximal end (302) multiple times the distance (e.g., 30 or 40 yards or even 80 yards, depending on the length of the strap) away from the initial point, and then secure the chip strap (300) with tees through the multiple grommets (350).

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include or be included within the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. An apparatus comprising:
a strap;
a set of target markings on the strap corresponding to a set of distances; and
a set of grommets inserted into the strap.

2. The apparatus of claim 1, wherein the strap is made of polypropylene webbing for durability and weather resistance.

3. The apparatus of claim 1, wherein the target markings are painted using high-contrast fabric paint.

4. The apparatus of claim 1, wherein the grommets are black self-piercing grommets with neck washers for added support.

5. The apparatus of claim 1, wherein the strap includes multiple grommets spaced at regular intervals of 5 yards.

6. The apparatus of claim 1, wherein the strap is 20 yards in length.

7. The apparatus of claim 1, wherein the target markings are numbers that indicate distances in yards.

8. The apparatus of claim 1, wherein the strap is yellow in color to provide high contrast for the target markings.

9. A method comprising:
extending a strap;
applying a set of target markings to the strap; and
inserting a set of grommets into the strap.

10. The method of claim 9, wherein the strap is made of polypropylene webbing.

11. The method of claim 9, wherein the target markings are applied using high-contrast fabric paint.

12. The method of claim 9, wherein the grommets are inserted at regular intervals of 5 yards.

13. The method of claim 9, wherein the grommets are black self-piercing grommets with neck washers.

14. The method of claim 9, wherein the strap is extended to a length of 20 yards.

15. The method of claim 9, wherein the target markings are numbers that indicate distances in yards.

16. The method of claim 9, wherein the strap is laid out flat on a clean, smooth surface before applying the target markings.

17. A method comprising:
securing a strap to a ground;
positioning a ball at a first end of the strap; and
hitting the ball towards a target marking on the strap.

18. The method of claim 17, wherein the strap is secured to the ground using golf tees inserted through the grommets.

19. The method of claim 17, wherein the strap is laid flat on the ground in a practice area, such as a yard, park, or golf course.

20. The method of claim 17,
wherein the ball is positioned at the proximal end of the strap,
wherein the golfer aims at one of the target markings on the strap and executes a chip shot,
wherein the strap remains taut and stable even in windy conditions,
wherein the golfer assesses the distance and accuracy of each chip shot after hitting the ball, and
wherein the strap is used to practice different distances by hitting the ball towards various target markings.
